(19) United States
(12) Patent Application Publication
(10) Pub. No.: US 2006/0250806 A1
(43) Pub. Date: Nov. 9, 2006

(54) Series decorative lamp ornament

(76) Inventor: Hon Kwok Cheng, Kowloon (HK)

Correspondence Address: RABIN & Berdo, PC, 1101 14TH STREET, NW, SUITE 500, WASHINGTON, DC, 20005, US

(21) Appl. No.: 11/123,052

(22) Filed: May 6, 2005

(51) Int. Cl. F21S 8/08

(52) U.S. Cl. 362/410

(57) ABSTRACT

The invention relates to a series decorative lamp ornament consisting of lamp-type ornamental members, a lamp line and gripping members, characterized in that the lamp-type ornamental members take shape of hollow thin-wall humans or animals; the lamp line is a water tube lamp or a string of lamps, and a series luminous body structure is made up of a plurality of the lamp-type ornamental members through which the lamp line runs from top to bottom; the gripping member is arranged at each of upper and lower joints of the lamp line and the lamp-type ornamental members to prevent the ornamental members from shifting along the lamp line.

### FIELD OF THE INVENTION

The present invention belongs to the field of everyday articles, and more particularly, relates to a decorative lamp ornament for festival decoration.

### BACKGROUND OF THE INVENTION

The existing decorative lamp ornaments are structurally simple in which common-use lamps are adopted as lamp fixtures. The lamp fixtures are distributed in a multiple-spot manner to illuminate or form patterns or characters, thus generating visual effects that are non-uniformly bright and unchangeable. The decorative effects of the existing decorative lamp ornaments will be impaired over time and high expenses are required for replacement purposes. Some of the lamp fixtures produce various decorative effects by use of sound, light and/or electricity techniques, and they are usually suitable to be put on the indoor furniture as a decoration. Some large-sized decorative lamp ornaments may produce impressive decorative effects using said techniques, but they are generally structurally complicated, manufacturally expensive and insufficiently adaptive to the market. In order to meet the demand in most cases, large-sized decorative lamp ornaments must be designed to meet the requirements of simple structure, esthetical decorative effect and low cost.

### SUMMARY OF THE INVENTION

To overcome the drawbacks with the existing decorative lamp fixtures, it is an object of the present invention to provide a series decorative lamp ornament having a novel structure useful for festival decoration. It has advantages of simple structure, easy operation, low cost of manufacture, and uniform and diverse illumination, thus generating excellent decorative effects.

In order to accomplish the aforesaid object, there is provided a series decorative lamp ornament consisting of lamp-type ornamental members, a lamp line and gripping members, characterized in that the lamp-type ornamental members take shape of hollow thin-wall humans or animals; the lamp line is a water tube lamp or a string of lamps, and a series luminous body structure is made up of a plurality of the lamp-type ornamental members through which the lamp line runs from top to bottom; the gripping member is arranged at each of upper and lower joints of the lamp line and the lamp-type ornamental members to prevent the ornamental members from shifting along the lamp line. Preferably, the lamp-type ornamental member is shaped into figurines such as a Santa Clause, a caballero or a human-shaped antler. Improvement has been made in brightness and uniformity of the invented series decorative lamp ornament, it will thus become clearly discernible and vivid as a whole with the lamp line serving as the luminous body. Further, the lamp line and other parts thereof are controllable, resulting in changes of lights with excellent decorative and eye-catching effects.

The invention will now be described in more detail with reference to the accompanying drawing.

### BRIEF DESCRIPTION OF THE DRAWINGS

FIG. 1 is a schematic diagram showing the construction of a preferred embodiment according to the invention.

### DETAILED DESCRIPTION OF THE INVENTION

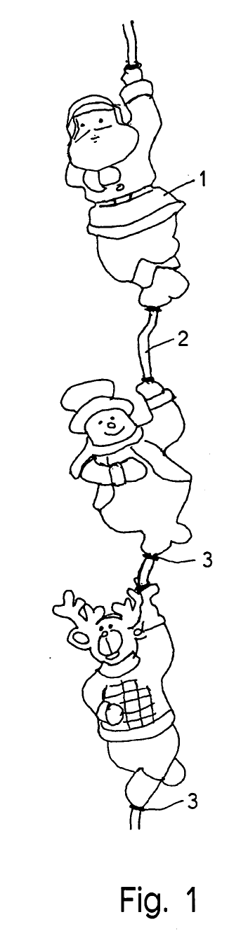

Referring to FIG. 1, the series decorative lamp ornament consists of lamp-type ornamental members 1, a lamp line 2 and gripping members 3, characterized in that the lamp-type ornamental members 1 take shape of hollow thin-wall humans or animals, they are processed and manufactured by blow molding; the lamp line 2 is either a water tube lamp or a string of lamps, and a series luminous body structure is made up of three to five lamp-type ornamental members 1, which is shaped into figurines such as a Santa Clause, a caballero or a human-shaped antler, through which the lamp line 2 runs from top to bottom; the gripping member 3 is arranged at each of upper and lower joints of the lamp line 2 and the lamp-type ornamental members 1 to prevent the ornamental members 1 from shifting along the lamp line 2. The on-off state of the lamp line 2 is controlled in a sequential manner. When used, the series decorative lamp ornament is simply hung up.

The series decorative lamp ornament according to the invention has advantages of simple structure, easy operation, low cost, uniform and diverse illumination, thus generating excellent decorative and eye-catching effects.

Numerous variations and modifications are easily obtainable by means of the skilled person's common knowledge without departing from the scope of the invention, however, such variations and modifications should fall into the scope of this invention.

What is claimed is:

1. A series decorative lamp ornament consisting of lamp-type ornamental members (1), a lamp line (2) and gripping members (3), characterized in that the lamp-type ornamental members (1) take shape of hollow thin-wall humans or animals; the lamp line (2) is a water tube lamp or a string of lamps, and a series luminous body structure is made up of a plurality of the lamp-type ornamental members (1) through which the lamp line (2) runs from top to bottom; the gripping member (3) is arranged at each of upper and lower joints of the lamp line (2) and the lamp-type ornamental members (1) to prevent the ornamental members (1) from shifting along the lamp line (2).

2. The series decorative lamp as claimed in claim 1, characterized in that the lamp-type ornamental member (1) is shaped into figurines such as a Santa Clause, a caballero or a human-shaped antler.
